(19) United States
(12) Patent Application Publication
(10) Pub. No.: US 2004/0246467 A1
(43) Pub. Date: Dec. 9, 2004

(54) Production method for a sensor head for optical current sensors

(76) Inventors: Klaus Bohnert, Oberrohrdorf (CH); Jurgen Nehring, Wettingen (CH)

Correspondence Address: BURNS DOANE SWECKER & MATHIS L L P, POST OFFICE BOX 1404, ALEXANDRIA, VA, 22313-1404, US

(21) Appl. No.: 10/486,983

(22) PCT Filed: Aug. 29, 2002
(86) PCT No.: PCT/CH02/00473

(30) Foreign Application Priority Data
Aug. 31, 2001 (EP) 01810843.1

(51) Int. Cl. G01C 1/00; G01B 11/26

(52) U.S. Cl. 356/138

(57) ABSTRACT

An optical current or magnetic field sensor has a sensor head which has a first phase delay element (13), a second phase delay element and a sensor fiber (15) The two phase delay elements (13) are optically connected to opposite ends of the sensor element (15), and the phase delay angle ρ on at least one of the phase delay elements (13) deviates by an angle ε, with ε≠0°, from 90°. Linearly polarized light waves (3) are injected into the first phase delay element (13), with a polarization axis (y′) of these linearly polarized light waves (3) including an angle which deviates from 45° by an angle Δα, with Δα≠0°, with a principal axis (y) of the first phase delay element (13). The angle Δα is selected as a function of at least the angle ε. This choice of the angle Δα makes it possible to compensate for non-linearities between a direct measurement signal and an electrical current or magnetic field to be measured which occur because of the angle ε≠0°.

### TECHNICAL FIELD

The present invention relates to the field of optical current and magnetic field sensor systems. It relates in particular to

a method for production of a sensor head as claimed in the precharacterizing clause of patent claim 1,

an optical current or magnetic field sensor as claimed in the precharacterizing clause of patent claim 12, and to a method for its production, and

to a method for measurement of an electrical current or magnetic field as claimed in the precharacterizing clause of patent claim 13.

### PRIOR ART

An optical current sensor such as this is known from EP 0 856 737 A1. This has a sensor fiber which is wound in the form of a coil, is magneto-optically active and surrounds an electrical conductor. At least at one end, the sensor fiber is connected via a phase delay element to a further optical fiber, a so-called supply fiber or return fiber, via which light can be injected into or output from the sensor fiber. The supply and return fibers preferably have an elliptical core cross section in which linearly polarized light waves propagate. A birefringent fiber segment, which is arranged between the sensor fiber and the supply fiber, acts as a phase delay element. This fiber segment has two optical major axes, a fast (short) principal axis and a slow (long) principal axis, which are aligned at 45° to the two major axes of the supply and return fibers. Its length is normally chosen in such a way that it acts as a λ/4 phase delay element, corresponding to a phase delay angle equivalent to an odd-numbered multiple of 90°. It therefore converts the linearly polarized light waves, which have been mentioned, in the supply and return fibers to circularly polarized light waves which propagate in the sensor fiber. EP 0 856 737 A1, which has been cited, specifies tolerance angles for the angle which has been mentioned between the major axes and for the phase delay angle of the phase delay element.

The sensor fiber is operated either as a Sagnac interferometer or, if it is mirrored at one of its ends, as a reflection interferometer. In both cases, two circularly polarized light waves propagate in the sensor fiber. In the case of a Sagnac interferometer, the waves in this case run in opposite directions while, in the case of a reflection interferometer, they run in the same direction. The two waves are polarized in the same sense in a Sagnac interferometer, being either left-hand or right-hand circularly polarized. They have opposite polarization senses in a reflection interferometer.

If an electrical current I flows through the electrical conductor, then the current I produces a magnetic field, which leads to a differential phase shift between these two light waves running in opposite directions or in the same direction. This effect is referred to as the magneto-optical effect or the Faraday effect. For circularly polarized light waves in the sensor fiber, the resultant phase shift is in this case proportional to the current and, in the Sagnac configuration, is:

ΔΦ_{S}=2φ_{F}

while, in the reflection configuration, it is:

ΔΦ_{R}=4φ_{F},

where the so-called Faraday phase shift φ_{F} is defined as

φ_{F}=VNI,

and where V is the Verdet constant of the sensor fiber, N is the number of fiber turns on the coil, and I is the current intensity.

The cited EP 0 856 737 A1 describes a sensor fiber which is admittedly free of mechanical stresses, so that the resultant measurement signal is not interfered with by temperature-dependent, stress-induced linear birefringence. The Verdet constant V of the sensor fiber is likewise dependent on the temperature, however, in a manner which is itself noticeable in the case of an ideal, stress-free fiber coil.

EP 1 115 000 discloses a fiber-optic current sensor which corrects for the influence of the temperature dependency of the Verdet constant V by using a phase delay element whose temperature dependency compensates for the temperature dependency of the Verdet constant V. This is achieved by the phase delay element having a phase delay angle which deviates by an angle ε≠0° from the phase delay angle of an ideal phase delay element. In the case of a λ/4 phase delay element, the phase delay angle is then 90°+ε instead of 90°, corresponding to typical phase delay angles of 95° to 105°. Depending on the mathematical sign of the temperature dependency of the Verdet constant V, negative angles ε are also possible. Phase delay elements such as these are preferably in the form of birefringent fiber segments with an elliptical core cross section, in which case the phase delay angle can then easily be set by appropriate choice of the length of the fiber segment. If a phase delay element such as this with ε≠0° is supplied with linearly polarized light waves via the supply fiber, with major axes of the supply fiber including an angle of 45° with those of the phase delay element, then slightly elliptical polarized light waves propagate in the sensor fiber.

One problematic feature of this type of compensation from the temperature dependency of the Verdet constant V is that it results in the relationship between the current to be measured and the measurement signal no longer being linear, with the measurement signal generally being proportional to ΔΦ_{S} or ΔΦ_{R}. This means that the linear relationships ΔΦ_{S}=2 V N I and ΔΦ_{R}=4 V N I which are applicable to circularly polarized light waves are no longer valid for elliptical light waves. Relationship non-linearities such as these between the current to be measured and the measurement signal are typically in the order of magnitude of 0.1% to 1% and cause measurement inaccuracies, and/or complicate the evaluation of the measurements where relatively good measurement accuracy is required. Non-linearities such as these can be compensated for by means of complex signal processing.

### DESCRIPTION OF THE INVENTION

The object of the invention is to provide an improved current or magnetic field sensor of the type mentioned initially, and a corresponding measurement method. This sensor is intended to overcome the disadvantages mentioned above. In particular, the sensor is intended to have better measurement accuracy and/or to simplify the evaluation of the measurement and to make it unnecessary to use complex signal processing.

This object is achieved by a method for production of a sensor head for an optical current or magnetic field sensor having the features of patent claim 1, and by a method for production of an optical current or magnetic field sensor as claimed in patent claim 11, and an optical current or magnetic field sensor as claimed in patent claim 12, and a method for measurement of an electrical current or a magnetic field having the features of patent claim 13.

The optical current or magnetic field sensor has a sensor head with a sensor element and two phase delay elements, as well as two light guiding elements. The components of the sensor head are arranged along a light path, and are optically connected to one another, in the sequence first light guiding element, first phase delay element, sensor element, second phase delay element, and second light guiding element. The phase delay angle ρ, ρ′ of at least one of the phase delay elements deviates by an angle ε≠0°, with −90°<ε<90°, from an odd-numbered multiple of 90°. According to the invention, a principal axis of at least one of the light guiding elements forms an angle of +45°±Δα with Δα≠0° and 0°<Δα<45° with a principal axis of the phase delay element which is adjacent to it, which formed angle is chosen as a function of at least the angle ε. Non-linearities between a direct measurement signal and an electrical current or magnetic field to be measured which result from ε≠0° can be compensated for at least approximately by appropriate ε-dependent choice of the angle Δα. This results in an at least approximately linear relationship between the direct measurement signal and the electrical current or magnetic field to be measured. This has the advantage that it allows simple evaluation of the measurement and a better measurement accuracy can be achieved without having to use complex signal processing.

In the method according to the invention for production of a sensor head for an optical current or magnetic field sensor, the stated components of the sensor head are arranged and dimensioned in the stated manner. In particular, the stated angle Au is chosen as a function of at least the angle ε.

The optical current or magnetic field sensor according to the invention has a sensor head which is produced using the method according to the invention. A sensor such as this, which is constructed using the Sagnac configuration, can be produced at low cost, since a commercially available detection unit can be used without any complex adaptations.

In a further embodiment of the invention, the two phase delay elements have phase delay angles which deviate by an odd-numbered multiple of 90°. This results in a more flexible design of the sensor head.

In a further embodiment of the invention, the angle Au is chosen as a function of ε in such a way that the stated non-linearities are reduced by at least half an order of magnitude, that is to say by a factor of 3, in comparison to the situation with Δα 0°.

In one preferred embodiment of the invention, the phase delay angles ρ, ρ′ of the two phase delay elements differ from one another by an amount ε, ε′, which is not equal to zero, of odd-numbered multiples of 90°, and the two phase delay elements together have a temperature dependency which at least approximately compensates for the temperature dependency of the Verdet constant V of the sensor element. This means that the two phase delay elements together make a contribution to the temperature dependency of the direct measurement signal such that the temperature dependency of the Verdet constant V of the sensor element is at least approximately compensated for. The temperature dependency which results from the combination of the two phase delay elements is thus chosen in the described manner. This means that the sensor not only has an at least approximately linear relationship between the direct measurement signal and the electrical current or magnetic field to be measured, but also better temperature stability.

In a further preferred embodiment of the subject matter of the invention, the phase delay angles ρ, ρ′ are also equal (ρ=ρ′ and ε=ε′). Furthermore, the relative alignment of the phase delay elements with respect to the light guiding elements which are in each case optically connected to them is chosen identically, that is to say at least one principal axis of the phase delay element forms the same angle Δα=Δα′ with at least one principal axis of the light guiding element, for both phase delay elements. This symmetrical configuration of the sensor head results in an improved production capability and a high degree of insensitivity to interference influences.

A further advantageous feature is for the linearly polarized light waves to be injected into the phase delay elements by means of polarization-maintaining fibers as the light guiding elements. This allows the means for producing the linearly polarized light waves to be arranged physically away from the phase delay elements and the sensor element, while the linearly polarized light waves are nevertheless always injected at the same angle.

In another preferred embodiment of the subject matter of the invention, at least one of the two phase delay elements, preferably both phase delay elements, is or are in the form of a fiber piece with an elliptical core, which has a phase delay angle of 90°+ε (or 90°+ε′). Phase delay elements such as these can be produced easily and at low cost.

It is advantageous to choose the sensor element such that it may have an electrical conductor in the form of a coil, because this allows the measurement accuracy and sensitivity of the sensor to be increased.

It is also advantageous to use a magneto-optically active glass fiber which is virtually free of mechanical stresses as the sensor element.-This reduces a temperature dependency of the sensor.

Further preferred embodiments are specified in the patent claims.

### BRIEF DESCRIPTION OF THE INVENTION

The subject matter of the invention will be explained in more detail in the following text with reference to preferred exemplary embodiments and the attached drawings, in which:

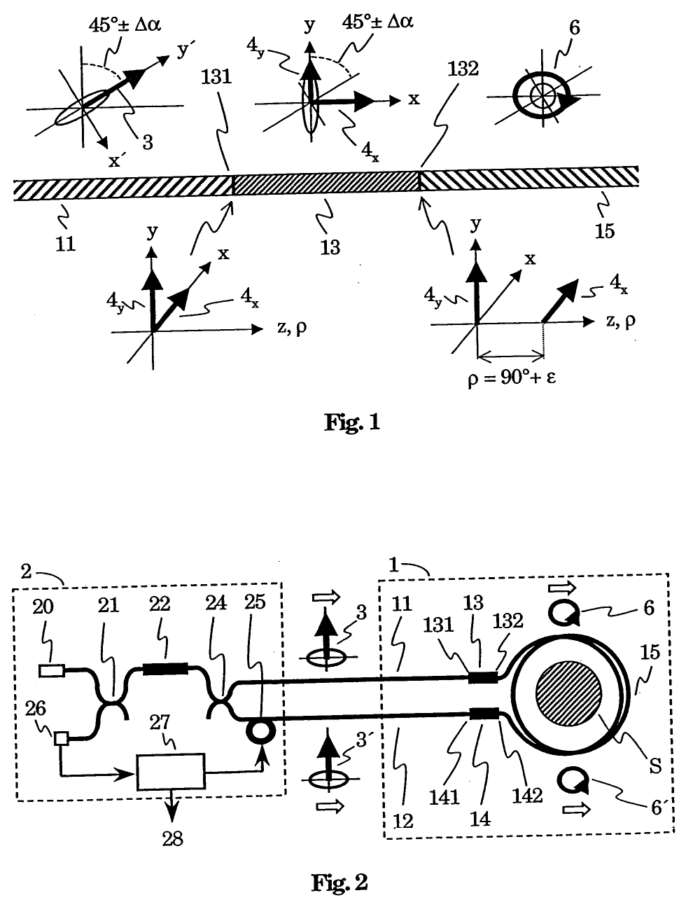

FIG. 1 shows a schematic illustration of a part of a sensor head according to the invention;

FIG. 2 shows a schematic illustration of a current or magnetic field sensor according to the invention in the Sagnac configuration;

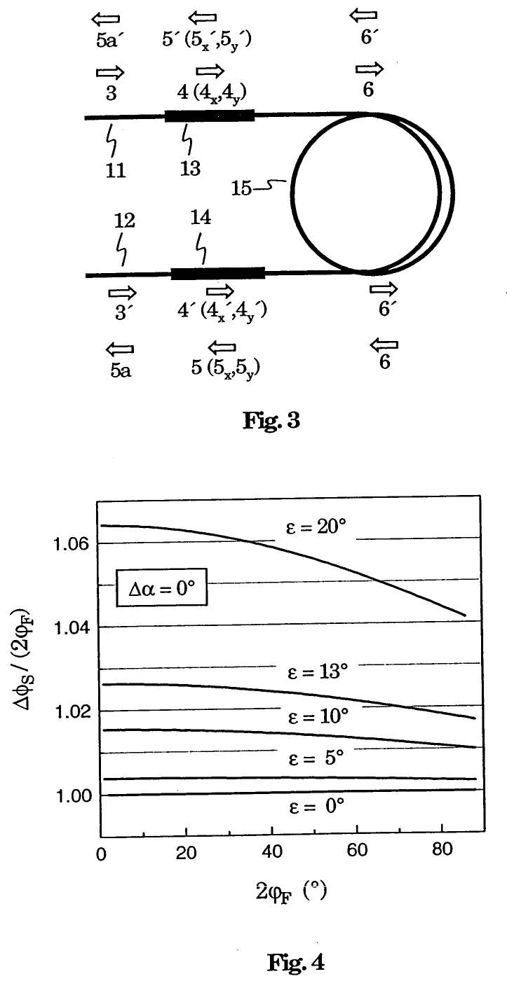

FIG. 3 shows a schematic illustration of the propagation direction of light waves which propagate in the sensor head during operation of a current or magnetic field sensor according to the invention;

FIG. 4 shows an illustration, in the form of a graph, of the calculated relationship between the differential phase shift ΔΦ_{S} (normalized with respect to 2φ_{F}) and twice the Faraday phase shift φ_{F}, 2φ_{F}=2 V N I for fast axes, which are aligned parallel to one another, of the phase delay elements (χ=0°) and Δα=Δ′=0°, for various angles ε;

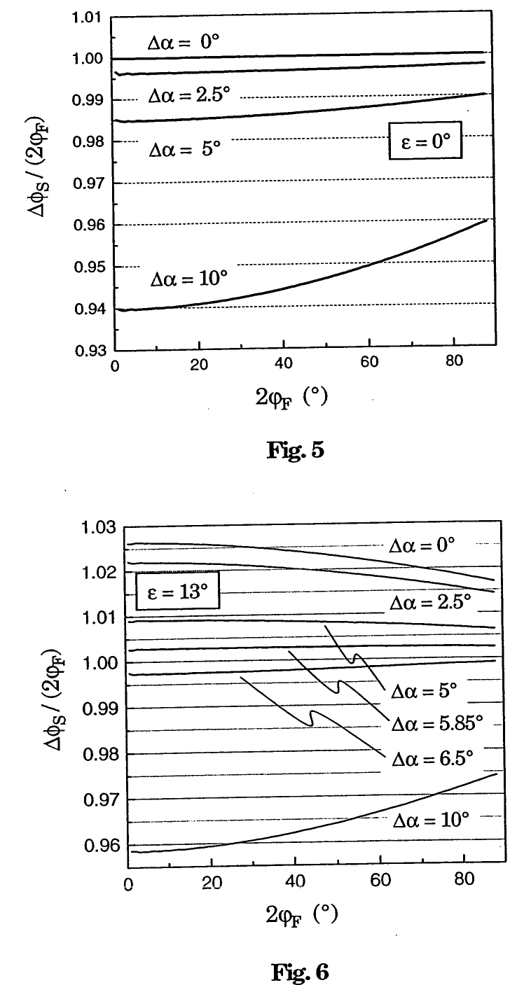

FIG. 5 shows an illustration, in the form of a graph, of the calculated relationship between the differential phase shift ΔΦφ_{S} (normalized with respect to 2φ_{F}) and twice the Faraday phase shift φ_{F}, 2φ_{F}=2 V N I, for fast axes, which are aligned parallel to one another, of the phase delay elements (χ=0°) and ε=0°, for various angles Δα=Δα′;

FIG. 6 shows an illustration, in the form of a graph, of the calculated relationship between the differential phase shift ΔΦ_{S} (normalized with respect to 2φ_{F}) and twice the Faraday phase shift φ_{F}, 2φ_{F}=2 V N I, for fast axes, which are aligned parallel to one another, of the phase delay elements (χ=0°) and ε=13°, for various angles Δα=Δα′.

The reference symbols used in the drawings and their meanings are listed in summarized form in the list of reference symbols. In principle, identical parts are provided with the same reference symbols in the figures. The described exemplary embodiments represent the subject matter of the invention in the form of examples, and have no restrictive effect.

### APPROACHES TO IMPLEMENTATION OF THE INVENTION

FIG. 1 shows a schematic diagram of a part of a sensor head 1 according to the invention for an optical current or magnetic field sensor. A first light guiding element 11 which is in the form of a polarization-maintaining optical fiber with an elliptical core cross section is optically connected to a first end 131 of a first phase delay element 13, that is to say light waves can be injected from the light guiding element 11 into the first end 131 of the first phase element 13, and vice-versa. A piece of fiber with an elliptical core cross section is used as the first phase delay element 13, and its length is chosen in such a way that its phase delay angle ρ=90°+ε, where the angle is ε≠0°. It is known from the initially cited EP 1 115 000, which represents an integral component of the present application, that skillful choice of the angle ε can lead to an improvement in the temperature stability of an optical current sensor. A second end 132 of the first phase delay element 13 is optically connected to a sensor element 15, which is preferably a magneto-optically active fiber with a round core cross section.

The three graphs in the upper part of FIG. 1 schematically illustrate light waves 3, 4ₓ, 4_{y}, 6 which propagate in the three fiber segments 11, 13, 15 which have been mentioned, as well as preferred core cross sections and major axes x, x′, y, y′. The light waves are represented by thick arrows which are intended to symbolize the E-field vectors of the light waves. First linearly polarized light waves 3 propagate in the first light guiding element 11 and in this case have a polarization axis y′ which coincides with the slow, long principal axis y′ of the first light guiding element 11. The principal axis y′ of the first light guiding element 11 forms an angle of 45°+Δα with a principal axis y of the first phase delay element 13, with Δα≠0° being an angle which is chosen as a function of the angle ε. When the first linearly polarized light waves 3 enter the first phase delay element 13 they become second linearly polarized light waves 4, comprising second linearly polarized light waves 4ₓ and second linearly polarized light waves 4_{y}, whose polarization axes lie along the two major axes x, y of the first phase delay element 13.

The two graphs in the lower part of FIG. 1 schematically illustrate the second linearly polarized light waves 4 in the first phase delay element 13. At the first end 131 of the first phase delay element 13, the second linearly polarized light waves 4_{y}, which are polarized along the slow principal axis y of the first phase delay element 13 are in phase with the second linearly polarized light waves 4ₓ, which are polarized along the fast principal axis x of the first phase delay element 13. After passing through the first phase delay element 13 along the propagation direction z, the phase difference ρ=90°+ε has accumulated at the second end 132 of the first phase delay element 13 between the light waves 4ₓ and the light waves 4_{y}.

The injection of the second linearly polarized light waves 4 into the sensor element 15 at the second end 132 of the phase delay element 13 results in elliptically polarized light waves 6 there, which then propagate in the sensor element 15.

FIG. 2 shows a current or magnetic field sensor according to the invention, which has a Sagnac configuration. The fundamental configuration and method of operation of the sensor will not be described in detail here. Appropriate information can be obtained from the initially cited prior art. In addition to the sensor head 1, the current or magnetic field sensor also has a transmission-evaluation-unit 2. In the illustrated example, this has a light source 20, a fiber coupler 21, a fiber polarizer 22, a second fiber coupler 24 and a phase modulator 25 as well as a detector 26, a signal processor 27 and a measured value output 28. The transmission-evaluation-unit 2 is used to produce and detect light, as well as for evaluation and outputting of measurement data.

FIG. 3 illustrates the propagation directions of the light waves which can propagate in the sensor head 1 during operation of the current or magnetic field sensor that is shown in FIG. 2. The open arrows above the reference symbols indicate the propagation direction. For reasons of clarity, FIG. 2 illustrates only a small number of light waves and propagation directions. The following explanatory notes refer to FIGS. 2 and 3.

The transmission-evaluation-unit 2 is connected to the sensor head 1 via the first light guiding element 11 and a second light guiding element 12 or corresponding extensions or connections. In addition to the first phase delay element 13, the sensor head 1 also has a second phase delay element 14 which, analogously to the first phase delay element 13, is optically connected at a first end 141 to the second light guiding element 12, and is optically connected at a second end 142 to a second end of the sensor element 15. The sensor element 15 is in the form of a magneto-optically active fiber, which surrounds an electrical conductor S in the form of a coil. The light guiding elements 11 and 12 are in the form of polarization-maintaining fibers with an elliptical core cross section.

Linearly polarized light is produced in the transmission-evaluation-unit 2, from which the first linearly polarized light waves 3 and 3′ are then produced in the two light guiding elements 11 and 12. These light waves 3, 3′ are symbolized as thick arrows in the illustrations in the center of FIG. 2. The open arrows indicate the propagation direction of the light waves 3, 3′.

The first linearly polarized light waves 3 from the first light guiding element 11 are converted, as described in conjunction with FIG. 1, by means of the (first) phase delay element 13 to elliptically polarized light waves 6, which then propagate in the sensor element 15. In this case, a principal axis of the first light guiding element 11 forms the said angle 45°+Δα with a principal axis of the first phase delay element 13, and the phase delay angle ρ of the first phase delay element 13 is ρ=90°+ε, as stated.

If an electrical current I flows through the electrical conductor S, then the elliptically polarized light waves 6 experience a magneto-optically induced phase shift due to the Faraday effect. After passing through the sensor fiber, the elliptically polarized light waves 6 are injected into the second end 142 of the second phase delay element 14, in which they are converted to the third linearly polarized light waves 5, comprising linearly polarized light waves 5ₓ and 5_{y}. These third linearly polarized light waves 5 stimulate in the second light guiding element 12 fourth linearly polarized light waves 5a, and these are then supplied via the second light guiding element 12 to the transmission-evaluation-unit 2, where the light waves are detected. Third light waves 5a, whose polarization axes are aligned at right angles to the polarization axis of the first linearly polarized light waves 3, can be blocked in the fiber polarizer 22, so that they are not detected.

The behavior of the first linearly polarized light waves 3′ in the second light guiding element 12 is analogous. The light waves which result from this are provided with dashed reference symbols. The first linearly polarized light waves 3′ are converted by means of the second phase delay element 14 to elliptically polarized light waves 6′, which then propagate in the sensor element 15, to be precise in a propagation direction which is the opposite to that of the elliptically polarized light waves 6. In this case, the principal axis of the second light guiding element 12 forms an angle of 45°+Δα′ with a principal axis of the second phase delay element 14, with an angle Δα′for which 0°≦Δα′<45°. The second phase delay element 14 has a phase delay angle ρ′ which deviates by an angle ε′ from 90° , that is to say ρ′=90°+ε′ Typically ε′≠0°.

A magnetic field which is produced as a result of an electrical current flowing in the electrical conductor S causes a magneto-optically induced phase shift in the elliptically polarized light waves 6′ due to the Faraday effect. After passing through the sensor element 15, the elliptically polarized light waves 6′ are injected into the second end 132 of the first phase delay element 13. Third linearly polarized light waves 5′ are produced, which comprise third linearly polarized light waves 5ₓ′ and 5_{y}′, and a phase shift of 90°+ε is produced between these third linearly polarized light waves 5ₓ′ and 5_{y}′. After this, fourth linearly polarized light waves 5a′ are produced at the first end 131 of the first phase delay element 13, and are then supplied via the first light guiding element 11 to the transmission-evaluation-unit 2, where the light waves are detected and the magneto-optically induced phase shift is determined. Third light waves 5a′, whose polarization axes are aligned at right angles to the polarization axis of the first linearly polarized light waves 3′, may be blocked in the fiber polarizer 22 so that they are not detected. The magneto-optically induced phase shift from the elliptically polarized light waves 6 or that from the elliptically polarized light waves 6′ which propagate in the opposite direction in the sensor element 15 may be used as a direct measurement signal in order to determine the electrical current I. The expression “direct” measurement signal is intended to mean that no signal processing has taken place in order to produce a signal which is at least approximately proportional to the electrical current I from the measurement signal.

In order to determine the magneto-optically induced phase shift easily in a sensor in the Sagnac configuration, the signal of the one elliptically polarized light waves 6 is preferably used as a reference signal for the other light waves 6′, which are elliptically polarized in the opposite direction. A differential phase shift ΔΦ_{S} is then produced between the two elliptically polarized light waves 6 and 6′ as a direct measurement signal. This direct measurement signal is precisely twice as great as the magneto-optically induced phase shift which each of the elliptically polarized light waves 6 and 6′ experiences in its own right. In the situation with ε=0°, ε′=0°, Δα=0°, Δα′=0°, as is known from EP 0 856 737 A1, this direct measurement signal then amounts to twice the Faraday phase shift φ_{F}2φ_{F}=2 V N I, and is thus proportional to the electrical current I.

If, as in the cited EP 1 115 000, ε≠0° and ε′≠0°, but Δα=0° and Δα′=0°, then the relationship between the direct measurement signal and the electrical current I is no longer linear. If the propagation of the elliptically polarized light waves 6, 6′ is described with the aid of Jones matrices and its differential phase shift ΔΦ_{S} is derived from the complex amplitudes of the two light waves which interfere with one another in the detector 26 in the transmission-evaluation-unit 2, then this results in the following expression for the direct measurement signal ΔΦ_{S}

$$Δ {φ}_{S} = arctan \frac{( cos ϵ + cos {ϵ}^{′} ) sin ( 2 {ϕ}_{F} )}{( 1 + cos ϵ cos {ϵ}^{′} ) cos ( 2 {ϕ}_{F} ) - sin ϵ sin {ϵ}^{′} cos ( {2}_{χ} )}$$

In this case, χ is the angle between the fast axes of the two phase delay elements 13 and 14. For the special case of χ=0° and ε=ε′, this results approximately, for small Faraday phase shifts φ_{F}/ in ΔΦ_{S}=2φ_{F}/COSε, which can be approximated as ΔΦ_{S}=2φ_{F} (1+ε²/2) for small angles ε. For the special case with χ=90° and ε=ε′, this results approximately in ΔΦ_{S}=2φ_{F}COSε for small φ_{F}, which can be approximated as ΔΦ_{S}=2φ_{F} (1−ε²/2) for small angles ε.

For ε=ε=13° and χ=0°, the relative discrepancy from linearity of the relationship between the direct measurement signal ΔΦ_{S} and the electrical current I to be measured is approximately −0.21% for 2φ_{F}=40°, and −0.92% for 2φ_{F}=90°. So far, it has also been assumed that Δα=0° and Δα′=0°, that is to say the major axes of the light guiding elements 11 and 12 each form an angle of precisely 45° with the major axes of the respective phase delay elements 13 and 14.

If, corresponding to the situation according to the invention, ε≠0°, and additionally Δα is chosen not to be equal to 0° and/or Δα′ is chosen not to be equal to 0°, then the relationship between the direct measurement signal ΔΦ_{S} and the Faraday phase shift φ_{F} proportional to the electrical current I is:

$$Δ {φ}_{S} = arctan \frac{⌊ ( cos ϵ cos ( 2 Δ α ) + cos {ϵ}^{′} cos ( 2 Δ {α}^{′} ) ⌋ sin ( 2 {ϕ}_{F} )}{{A}_{1} cos ( 2 {ϕ}_{F} ) + {A}_{2} cos ( {2}_{χ} ) - {A}_{3} sin ( {2}_{χ} )}$$

$$where$$

$${A}_{1} = 1 + cos ϵ cos {ϵ}^{′} cos ( 2 Δ α ) cos ( 2 Δ {α}^{′} )$$

$${A}_{2} = sin ( 2 Δ α ) sin ( 2 Δ {α}^{′} ) - sin ϵ sin {ϵ}^{′} cos ( 2 Δ α ) cos ( 2 Δ {α}^{′} )$$

$${A}_{3} = sin ϵ cos ( 2 Δ α ) sin ( 2 Δ {α}^{′} ) + sin {ϵ}^{′} cos ( 2 Δ {α}^{′} ) sin ( 2 Δ α )$$

Thus, as can be seen from FIG. 6, the non-linear relationship between the direct measurement signal ΔΦ_{S} and the electrical current I can be influenced by the choice of the angles Δα and Δα′, so that the non-linearity is reduced. Skillful choice of the angles Δα and Δα′ as a function of the angles ε and ε′ allows this non-linearity, which results from ε≠0° and/or ε′≠0°, being at least approximately compensated for. There is then an at least approximately linear relationship between the direct measurement signal ΔΦ_{S} and the electrical current I. In general, the non-linearity can be reduced by at least half an order of magnitude, that is to say by a factor of 3, in comparison to the situation with Δα=Δα′=0°. Owing to the difference between the functional relationships for the angles ε, ε′ and for the angles Δα, Δα′, complete compensation for the non-linearity in the mathematical sense is impossible. However, the non-linearity can be reduced and compensated for to such an extent that it is insignificant in practice.

As can be seen from the above equation, the mathematical signs of the angles Δα and Δα′ are irrelevant since they behave symmetrically with respect to these mathematical signs. Only the magnitudes of the angles Δα and Δα′ are of importance. One example of how the angles are calculated for at least approximate compensation is given in the following text for a sensor configuration in which the fast axes of the phase delay elements 13, 14 are aligned parallel to one another, that is to say χ=0°.

FIG. 4 shows the relationship calculated using the above equation between the direct measurement signal ΔΦ_{S} and twice the Faraday phase delay angle 2Δφ_{F} for χ=0°, Δα=Δα′=0° and various angles ε=ε′. ΔΦ_{S} is in this case normalized with respect to 2φ_{F}.

This clearly shows that the non-linearity increases for relatively large angles ε. The magnitude of the non-linearities is in the parts per thousand or parts per hundred range. For ε=13°, the relative non-linearity is −0.21% for 2φ_{F}=40°, and −0.92% for 2φ_{F}=90°. These non-linearities are calculated using

{ΔΦ_{S}/(2φ_{F})[2φ_{F}=40°]−ΔΦ_{S}/(2φ_{F})[2φ_{F}=0°]}/ΔΦ_{S}/(2φ_{F})[2φ_{F}=0°]

and

{ΔΦ_{S}/(2φ_{F})[2φ_{F}=90°]−ΔΦ_{S}/(2φ_{F})[2φ_{F}=0°]}/ΔΦ_{S}/(2φ_{F})[2φ_{F}=0°],

that is to say from the difference from ΔΦ_{S}/(2φ_{F} for 2φ_{F}=40° and/or 2φ_{F}=90° and ΔΦ_{S}/(2φ_{F}) for 2φ_{F}=0°, normalized using ΔΦ_{S}/(2φ_{F}) for 2φ_{F}=0°.

FIG. 5 shows the relationship calculated in accordance with the above equation for χ=0° between the direct measurement signal ΔΦ_{S} and twice the Faraday phase delay angle, 2ΔΦ_{S}, for the situation with ε=ε=0° for various angles Δα=Δα′. ΔΦ_{S} is in this case normalized with respect to 2φ_{F}. This clearly shows that the non-linearity increases for larger angles as. The magnitude of the non-linearities is in the parts per thousand range. As can be seen, the curvature of the curves in FIG. 5 is in the opposite direction to the curvature of the curves in FIG. 4. This opens up the possibility of providing the said compensation according to the invention for non-linearities which are caused by ε≠0° and/or by ε′≠0° by skillful choice of the angle Δα, Δα′.

FIG. 6 shows the relationship, calculated according to the above equation, between the direct measurement signal ΔΦ_{S} and twice the Faraday phase delay angle, 2ΔΦ_{S}, for the situation with ε=ε′=13° and χε=0° for various angles Δα=Δα′. ΔΦ_{S} is in this case normalized with respect to 2φ_{F}. This clearly shows that the non-linearity caused by ε not being equal to 0° is compensated for at least approximately for angles Δα around 5.85°. This allows the angle Δα according to the invention to be determined graphically.

However, it is preferable to calculate Δα as a function of ε. For a given phase delay angle ρ=ρ′, that is to say for the given angle ε=ε′, the angle Δα=Δα′ according to the invention can be calculated as follows, using the equation specified above:

In practice, the function ΔΦ_{S}(ε=ε′, Δα=Δα′, φ_{F})/2φ_{F} should be independent of 2φ_{F}, particularly for values of 2φ_{F} between 0° and 90°. The angle Δα=Δα′ to be chosen for this purpose is obtained from

ΔΦ_{S}(ε, Δα=Δα′, φ_{F}=0°)/(2φ_{F})=ΔΦ_{S}(ε, Δα=Δα′, φ_{F}=90°)/(2φ_{F})

This equation can be solved numerically. Alternatively, the following analytical expression is also obtained for χε=0° and for small angles ε:

sin²(2Δα)≈sin² ε−2[(π−1)/(π−2)] sin⁴ ε+ . . .

Higher-order terms are omitted here. As an approximate solution for Δα=Δα′, this results in:

Δα≈±(1/2) arcsin {sin² ε−2[(π−1)/(π−2)] sin⁴ ε}^{1/2}

For ε=13°, this equation results in Δα=±5.85° (see also FIG. 6). In this case, the ratio ΔΦ_{S}/2φ_{F} between 2φ_{F}=0° and 2φ_{F}=90° varies by less than 0.02%. It therefore varies by a factor of virtually 50 and is thus more than one and a half orders of magnitude less than the 0.92% stated above for the situation with Δα=Δα′=0°. If even further linearization is desired, then an iterative method can be used to minimize this variation in a predetermined value range of the variables 2φ_{F}, for example between 2φ_{F}=0° and 2φ_{F}=90°. Δα=+5.9° is then obtained as the optimum angle for ε≠13°. The procedure in the case of a sensor for which χ≠0° is completely analogous. The situation of fast axes of the phase delay elements 13, 14 which are aligned orthogonally with respect to one another are of particular interest, that is to say χ=90°. With the parameters otherwise unchanged, this results in Δα=Δα′=±6.80 for optimum compensation for the non-linearities for χ=90°.

Numerous other variants are possible in addition to the exemplary embodiments discussed in conjunction with FIG. 2. The light guiding elements 11, 12 may also be in the form of different types of polarization-maintaining optical fibers, such as so-called panda fibers, Bowtie fibers or fibers with additional, internal, elliptical cladding (fiber lining). Alternatively, it is also feasible to introduce the first linearly polarized light waves 3, 3′ into the phase delay elements 13, 14 directly or by means of a lens or an optical assembly. In this case, the light guiding elements 11, 12 would be air or a vacuum, or the lens or the optical assembly. The major axes of the light guiding elements 11, 12 are always those axes which are determined by the polarization vectors of the first linearly polarized light waves 3, 3′.

The optical connections between the phase delay elements 13, 14 and the light guiding elements 11, 12 or the sensor element 15 may be direct connections, such as those produced by being welded together by means of a so-called splicer. Alternatively, connections may be provided by an intermediate medium, for example a gel, adhesive or a fiber piece, or an optical assembly. Alternatively, light waves are injected through a vacuum or through a gas.

The phase delay elements 13, 14 may be optical fiber pieces with geometrically induced birefringence, for example by means of an elliptical core, or with stress-induced birefringence, such as bow-tie or panda fibers, or fibers with an internal elliptical lining. They may also be in the form of loops of conventional monomode fibers with a round core. In this case, the phase delay is produced by birefringence which is caused by the fiber curvature. Furthermore, λ/4 platelets are also feasible. The phase delay angles ρ, ρ′ may deviate by angles ε, El from any desired odd-numbered multiple of 90°. The angles ε, ε′ are preferably predetermined in such a way that they are just sufficiently large to compensate for the temperature dependency of the Verdet constant of the sensor element 15 by means of the temperature dependency of the phase delay elements 13, 14. This may result in both positive and negative angles ε, ε′.

The angles ε and ε′ may have different magnitudes. Furthermore, for any given angle χ, there are generally a large number of different pairs of angles Δα, Δα′, which lead to at least approximate compensation for the non-linearities that result from ε not being equal to 0° and/or ε not being equal to 0°. Nevertheless, the choice of Δα is in this case still dependent on ε, but Δα in this case additionally depends on ε′ and Δα′ as well as χ. It can thus be said that Δα and Δα′ are chosen as a function of at least the angles ε and ε′. The angle χ forms another influencing variable.

As stated above, the sensor element 15 may surround the electrical conductor S in the form of a coil, preferably with a number of turns. However, fractions of a turn are also possible and differently curved or uncurved sensor elements 15 may also be used. The sensor element 15 preferably comprises an optical fiber which is free of mechanical stresses, as described in EP 0 856 737 A1. It is particularly advantageous to use a stress-free sensor fiber 15 such as this together with a phase delay-element 13, 14 to compensate for the temperature dependency, as is described in EP 1 115 000. A current or magnetic field sensor according to the invention such as this is in practice independent of temperature, but has a linear relationship between a current I to be measured and the direct measurement signal ΔΦ_{S}.

Apart from magneto-optically active fibers, it is also possible to use solid glasses or magneto-optical crystals, such as yttrium iron granate, Y₃ FE₅ O₁₂, as the sensor element 15. These variants are particularly advantageous if the current or magnetic field sensor is used for local measurement of magnetic fields. The sensor element 15 must be operatively connected to the magnetic field to be measured, preferably at a location at which the magnetic field is large, so that the elliptically polarized light waves 6, 6′ experience as large a magneto-optically induced phase shift as possible caused by the magnetic field. Furthermore, it is also possible to use two or more sensor elements 15 in one sensor head 1.

The angles ε, ε′ and Δα, Δα′ are subject to the conditions 0°<ε, ε′<90° and 0°<Δα, Δα′<45°, in which case it is also possible for Δα′ to be 0° and/or for ε′ to be 0°. Since, as stated above, the mathematical sign of Δα is irrelevant, a restriction to positive Δα is also feasible. If ε, ε′ are chosen for the temperature compensation as mentioned above, then, based on the fiber materials that are now available, this results in values of up to about 20° for ε, ε′when ε=ε′ and χ=0° or χ=90° . Angles ε of less than about 30° are therefore preferably used. Values of ε such as this result in angles Δα of up to about 10°. As mentioned above, if Δα≠Δα′, it is possible to choose different pairs Δα, Δα′ according to the invention, so that angles Δα of more than 10° are also possible according to the invention, if ε=30°.

Both interferometrically and polarimetrically detecting variants may be used as the transmission-evaluation-unit 2. The various possible ways to evaluate the direct measurement signals are known from the prior art. In the example shown in FIG. 2, the one set of elliptically polarized light waves 6 was in each case used as a reference signal for the other elliptically polarized light waves 6′, with both being subject to the influence of the electrical current I or of the magnetic field. However, it is also possible to measure the magneto-optically induced phase shift without having to use mutually different elliptically polarized light waves 6 and 6′. For example, linearly polarized light waves which do not suffer any magneto-optically induced phase shift can be produced within the transmission-evaluation-unit 2, and with respect to which the magneto-optically induced phase shifts on the elliptically polarized light waves 6 or 6′ can be determined.

A low coherence semiconductor source is typically used as the light source 20, such as a superluminescence diode, a multimode laser diode, a laser diode operated below the laser threshold, or a light emitting diode (LED), preferably with wavelengths around about 800, 1300 or 1550 nanometers. However, it is possible to use widely differing wavelengths, for example on the ultraviolet, visible or infrared bands.

The angles Δα, Δα′ are therefore chosen during the production of a sensor head according to the invention as a function of at least the angle ε (or ε′) in such a way that the non-linearities which have been mentioned are considerably reduced or are even at least approximately compensated for. This may be achieved, for example, by one of the ways described above. It is also possible to speak of a defined angle Δα which is chosen according to the invention. This is clearly delineated from randomly occurring angles Δα which, for example, are subject to tolerances and are preferably as small as possible, that is to say are approximately 0°. When implementing the invention, it is irrelevant whether an angle which deviates slightly from the optimum angle Δα is produced, for example as a result of manufacturing tolerances. The essential feature is that a defined angle Δα is chosen on the basis of reducing the stated non-linearities, and/or that an appropriate result is achieved.

### List of Reference Symbols

1 Sensor head

11 First light guiding element

12 Second light guiding element

13 First phase delay element

131 First end of the first phase delay element

132 Second end of the first phase delay element

14 Second phase delay element

141 First end of the second phase delay element

142 Second end of the second phase delay element

15 Sensor element

2 Transmission-evaluation-unit

20 Light source

21 Fiber coupler

22 Fiber polarizer

24 Secondfiber coupler.

25 Phase modulator

26 Detector

27 Signal processor

28 Measurement value output

3, 3′ First linearly polarized light waves

4,4ₓ,4_{y},4′,4ₓ′,4_{y}′ Second linearly polarized light waves

5, 5′ Third linearly polarized light waves

5a, 5a′ Fourth linearly polarized light waves

6, 6′ Elliptically polarized light waves

I Electrical current, current intensity

N Number of turns

S Electrical conductor

V Verdet constant

Δα Angle by which the injection angle into the (first) phase delay element deviates from 45°

Δα′ Angle by which the injection angle into the (second) phase delay element deviates from 45°

ΔΦ_{S} Differential phase shift for the Sagnac configuration, direct measurement signal for the Sagnac configuration

ε Angle by which the phase delay angle ρ of the (first) phase delay element deviates from an odd-numbered multiple of 90°

ε′ Angle by which the phase delay angle ρ′ of the (second) phase delay element deviates from an odd-numbered multiple of 90°

φ_{F} Faraday phase shift, φ_{F}=V N I

ρ Phase delay angle of the (first) phase delay element

ρ′ Phase delay angle of the (second) phase delay element

χ Angle

1. A method for production of an optical current or magnetic field sensor, which comprises a transmission-evaluation-unit and a sensor head, wherein the transmission-evaluation-unit can produce light at a wavelength λ, and wherein head comprises a first light guiding element, a second light guiding element, a first phase delay element, a second phase delay element and a sensor element, with each of the two light guiding elements each having at least one principal axis, with each of the two phase delay elements each having at least one principal axis, with elliptically polarized light waves being able to propagate in the sensor element, which experience a magneto-optically induced phase shift caused by an electrical current or magnetic field to be measured,
with a first end of the first phase delay element being optically connected to the first light guiding element, and a second end of the first phase delay element being optically connected to a first end of the sensor element,
with a first end of the second phase delay element being optically connected to the second light guiding element, and a second end of the second phase delay element being optically connected to a second end of the sensor element,
with the transmission-evaluation-unit being optically connected to the first light guiding element and to the second light guiding element,
with the first phase delay element being dimensioned in such a way that its phase delay angle ρ deviates by an angle ε, with ε≠0° and −90°<ε<90°, from an odd-numbered multiple of 90°, and
with the second phase delay element being dimensioned in such a way that its phase delay angle ρ′ deviates by an angle ε′, with ε′≠0° and −90°<ε′<90° from an odd-numbered multiple of 90°, and
with the first light guiding element being aligned relative to the first phase delay element in such a way that the at least one principal axis of the first light guiding element forms with the at least one principal axis of the first phase delay element an angle, which deviates from 45° by an angle Δα,
wherein for the angle Δα applies: 0°<Δα<45°, and in that the angle Δα is chosen as a function of at least the angles ε and ε′ in such a way that non-linearities in the relationship between the magneto-optically induced phase shift of the elliptically polarized light waves and the electrical current or magnetic field to be measured, which occur when a current or magnetic field measurement is carried out by means of the optical current or magnetic field sensor, are reduced in comparison to the situation with Δα=0°.

2. The production method as claimed in claim 1, wherein the angle Δα is chosen as a function of at least the angle ε in such a way that the non-linearities in the relationship between the magneto-optically induced phase shift of the elliptically polarized light waves and the electrical current or magnetic field to be measured, which occur in the case of a current or magnetic field measurement by means of the optical current or magnetic field sensor, are reduced by at least a factor of 3 in comparison to the situation with Δα=0°.

3. The production method as claimed in claim 1, wherein phase delay elements are used which together have a temperature dependency which at least approximately compensates for a temperature dependency of a Verdet constant of the sensor element.

4. The production method as claimed in claim 3, wherein the two phase delay elements are dimensioned in such a way that their phase delay angles ρ, ρ′ are equal, and that the second light guiding element is aligned relative to the second phase delay element in such a way that the at least one principal axis of the second light guiding element forms with the at least one principal axis of the second phase delay element an angle which deviates from 45° by an angle Δα′ with 0°<Δα′<45°, and
wherein the angles Δα and Δα′ are chosen to be of the same magnitude.

5. The production method as claimed in claim 1, wherein polarization-maintaining fibers are used as the light guiding elements, and wherein these are connected to the phase delay elements.

6. The production method as claimed in claim 1, wherein a piece of fiber with an elliptical core is used as the at least one of the two phase delay elements, which piece of fiber is dimensioned such that its phase delay angle ρ, ρ′ deviates by the angle ε, ε′ from 90°.

7. The production method as claimed in claim 1, wherein a sensor element is used which can be arranged in such a way that it surrounds an electrical conductor in the form of a coil.

8. The production method as claimed in claim 7, wherein a magneto-optically active fiber with a round core cross section is used as the sensor element, and which is virtually free of mechanical stresses.

9. The production method as claimed in claim 1, wherein the magnitude of the angle ε is chosen to be less than 300, and wherein the angle Δα is chosen to be less than 10°.

10. An optical current or magnetic field sensor, comprising a transmission-evaluation-unit and a sensor head, wherein the transmission-evaluation-unit can produce light at a wavelength A, and wherein the sensor head comprises a first light guiding element, a second light guiding element, a first phase delay element, a second phase delay element and a sensor element, with each of the two light guiding elements each having at least one principal axis, with each of the two phase delay elements each having at least one principal axis, with elliptically polarized light waves being able to propagate in the sensor element, which experience a magneto-optically induced phase shift caused by an electrical current or magnetic field to be measured, wherein a first end of the first phase delay element being optically connected to the first light guiding element, and a second end of the first phase delay element m being optically connected to a first end of the sensor element,
with a first end of the second phase delay element being optically connected to the second light guiding element, and a second end of the second phase delay element being optically connected to a second end of the sensor element, with the transmission-evaluation-unit being optically connected to the first light guiding element and to the second light guiding element,
with the first phase delay element being dimensioned in such a way that its phase delay angle ρ deviates from an odd-numbered multiple of 90° by an angle ε, with ε≠0° and −90°<ε<90°,
with the second phase delay element being dimensioned in such a way that its phase delay angle ρ′ deviates from an odd-numbered multiple of 90° by an angle ε′, with ε′≠0° and −90°<ε′<90°, and
with the first light guiding element being aligned relative to the first phase delay element in such a way that the at least one principal axis of the first light guiding element forms with the at least one principal axis of the first phase delay element an angle, which deviates from 45° by an angle Δα,
wherein for the angle Δα applies: 0°<Δα<45°, and wherein the angle Δα is chosen as a function of at least the angles ε, ε′ in such a way that non-linearities in the relationship between the magneto-optically induced phase shift of the elliptically polarized light waves and the electrical current or magnetic field to be measured, which occur when a current or magnetic field measurement is carried out by means of the optical current or magnetic field sensor, are reduced by a factor of at least 3 in comparison to the situation Δα=0°.

11. A method for measurement of an electrical current or of a magnetic field, with first linearly polarized light waves being produced in a transmission-evaluation-unit and being injected into a first end of a first phase delay element,
with second linearly polarized light waves being stimulated in the first phase delay element by the first linearly polarized light waves, which second linearly polarized light waves, pass through the first phase delay element and in consequence are phase-shifted by an angle ρ with respect to one another,
with the second linearly polarized light waves stimulating elliptically polarized light waves in a sensor element whose first end is connected to a second end of the first phase delay element, which elliptically polarized light waves experience a magneto-optically induced phase shift as a result of the electrical current or the magnetic field,
with the elliptically polarized light waves then being injected into a second phase delay element, whose second end is connected to a second end of the sensor element,
with third linearly polarized light waves being stimulated in the second phase delay element by the elliptically polarized light waves, which third linearly polarized light waves pass through the second phase delay element and in consequence are phase-shifted by an angle ρ′ with respect to one another,
with the third linearly polarized light waves being output from a first end of the second phase delay element and stimulating fourth linearly polarized light waves which are supplied to the transmission-evaluation-unit,
with the fourth linearly polarized light waves being detected and measurement data being evaluated in the transmission-evaluation-unit,
with the angle ρ deviating from an odd-numbered multiple of 90° by an angle ε with ε≠0° and −90°<ε<90°, and with the angle ρ′ deviating from an odd-numbered multiple of 90° by an angle ε′, with ε′≠0° and −90′<ε′<90°, and
with a polarization axis of the first linearly polarized light waves being aligned relative to a polarization axis of the second linearly polarized light waves and/or a polarization axis of the third linearly polarized light waves being aligned relative to a polarization axis ) on the fourth linearly polarized light waves in such a way that the corresponding polarization axes form an angle which deviates from 45° by an angle Δα,
wherein for the angle Δα applies: 0°<Δα<45°, and
wherein the angle Δα is chosen as a function of at least the angles ε, ε′ in such a way that non-linearities in the relationship between the magneto-optically induced phase shift of the elliptically polarized light waves and the electrical current or magnetic field to be measured, are reduced in comparison to the situation with Δα=0°.
